(19) United States
(12) Patent Application Publication
(10) Pub. No.: US 2005/0076987 A1
(43) Pub. Date: Apr. 14, 2005

(54) Acoustic signal monitoring system for a tire

(76) Inventors: George Phillips O'Brien, Piedmont, SC (US); William A. Downey, Simpsonville, SC (US)

Correspondence Address: DORITY & MANNING, PA & MICHELIN NORTH AMERICA, INC, P O BOX 1449, GREENVILLE, SC, 29602-1449, US

(21) Appl. No.: 10/681,895

(22) Filed: Oct. 9, 2003

(51) Int. Cl. B60C 23/10

(52) U.S. Cl. 152/415

(57) ABSTRACT

An apparatus for monitoring a condition of a tire, such as tread belt separation, includes at least one sound monitoring device that is carried by a vehicle. The sound monitoring device produces a sound monitoring device output signal that is representative of the sound produced by at least one of the tires during rotation. A signal processing device is also present and includes a neural network. The signal processing device receives and processes the sound monitoring device output signal. A processing device output signal that is representative of a potential damage condition of the tire is produced. An indication device is present and receives the processing device output signal. The indication device informs a user of the vehicle that the tire is experiencing the potential damage condition.

### TECHNICAL FIELD

The present invention relates generally to tires and tire assemblies for pneumatic tubeless tires. More particularly, the present invention relates to an acoustic monitoring system for use with a tire for indicating whether the tire is experiencing an undesirable operating condition, such as tread belt separation.

### BACKGROUND

Pneumatic tires on a vehicle should be properly maintained by the operator of the motor vehicle in order to ensure the best possible performance and safety of the vehicle. In certain instances such as when tires are under-inflated, overloaded, and driven in hot climates the tire may experience damage, including tread belt separation. Here, the radial belt becomes separated from the tread section of the tire rendering the tire unusable.

A tire will make a different sound upon being rotated once tread belt separation begins. This sound has been described as a “whooping” sound. Therefore, it is possible to detect tread belt separation upon listening for and recognizing this sound. One patent seeking to detect hazardous conditions in tires through the use of an audible monitoring apparatus was disclosed in Aduddell (U.S. Pat. No. 5,436,612), the entire disclosure of which is incorporated herein by reference in its entirety for all purposes. In Aduddell, the sound monitoring assemblies are placed on the undercarriage of a vehicle and transmit the sound produced by the rotating tires to a speaker assembly located inside of the vehicle. The driver of the vehicle may then hear the sounds produced by the tire through this speaker assembly as the vehicle is operated.

This type of an arrangement requires the driver to be adequately trained and skilled in order to audibly detect a change in the sound made by a tire as it begins to experience tread belt separation. Detection of tread belt separation therefore depends on the ability of the driver to discern a change in sound, and the driver's own diligence in constantly monitoring and listening for a particular sound. It could be the case that the driver of the vehicle will “zone out” the sounds transferred through the speaker assembly after hours and hours of driving. In this instance, the driver may not be able to adequately detect the sound of a tread belt separation because the driver has become accustomed to the sounds transferred through the speaker assembly and is not in fact listening for any particular sound. Additionally, vehicles are typically designed in order to prevent environmental sounds from entering the vehicle and disturbing the drivers and occupants. Reintroducing outside sounds that the vehicle makes into the interior of the vehicle results in a distracting and annoying condition for the occupants of the vehicle.

The present invention improves upon prior devices that have attempted to inform drivers of tread belt separation through acoustic monitoring.

### SUMMARY

Various features and advantages of the invention will be set forth in part in the following description, or may be apparent from the description.

The present invention provides for an acoustic signal monitoring system for a tire. The monitoring system is capable of alerting the driver of the vehicle to the fact that one or more tires on the vehicle are experiencing an undesirable condition, such as tread belt separation. The monitoring system employs a sound monitoring device, such as a microphone, in order to detect the sound made by a tire or tires of the vehicle as the vehicle is driven. A neural network is incorporated into the monitoring system in order to receive and process the sound detected by the sound monitoring device. The neural network compares this sound with sounds made by tires that have the potential damage condition. The neural network then determines whether the sound made by the tire or tires indicates the potential damage condition, and if so the driver and/or occupants of the vehicle will be appropriately notified.

In one exemplary embodiment of the present invention, the sound monitoring device produces a sound monitoring device output signal that is representative of the sound produced by at least one of the tires. A signal processing device is in communication with the sound monitoring device and incorporates the neural network. The signal processing device produces a processing device output signal representative of the potential damage condition of the tire as determined by the neural network. An indication device is incorporated that receives the processing device output signal and indicates to the occupants that the tire is experiencing the potential damage condition. In various exemplary embodiments of the present invention, this indication device may be a lamp, a light emitting diode, a gage, and/or an audio indicator.

The neural network may process the sound monitoring device output signal in a number of ways. For instance, the neural network may compare the harmonics in the sound monitoring device output signal to known harmonics representative of the potential damage condition of the tire. Alternatively or additionally, the neural network may compare the amplitude and phase angle for each harmonic frequency in the processing device output signal to known amplitudes and phase angles indicative of the potential damage condition.

The sounds input into the acoustic signal monitoring system may be from tires that have various degrees or percentages of tread belt separation. Further, sounds from tires of different sizes, configurations, or manufacturers that have various degrees or percentages of tread belt separation may be used in conjunction with the monitoring system. Further, the monitoring system may be configured to identify sounds made by tires on different makes and models of vehicles that all have various degrees or percentages of tread belt separation. Additionally, the sound monitoring device may be located in a single wheel well of the vehicle, in various wheel wells of the vehicle, or on the undercarriage of the vehicle. The acoustic signal monitoring system may be configured so as to be able to incorporate sounds from these various monitoring devices on various locations of the vehicle.

The neural network incorporated into the acoustic signal monitoring system may be of any type. For instance, it may be a trained system or may be one that is self taught. It may be a feed forward or a recurrent system. The neural network may be configured to be able to analyze tires on a particular make and model of vehicle, or may be configured to be used on various types of makes and models of vehicles. The neural network may be configured to be as simple or complex as desired. For instance, the neural network may be trained with sounds coming from various types, sizes, and manufacturers of tires all having various percentages of tread belt separation that are made from operation in different altitudes, weather conditions, and tread wear conditions.

### BRIEF DESCRIPTION OF THE DRAWINGS

FIG. 1 is a partial perspective view of a vehicle having a wheel well with a tire located therein. A sound monitoring device in accordance with one exemplary embodiment of the present invention is shown positioned within the wheel well and located proximate to the tire.

FIG. 2 is a bottom plan view of a vehicle. A pair of sound monitoring devices are located on the undercarriage of the vehicle in accordance with one exemplary embodiment of the present invention.

FIG. 3 is a bottom plan view of a vehicle. Four sound monitoring devices are shown located in separate wheel wells of the vehicle in accordance with one exemplary embodiment of the present invention.

FIG. 4 is a partial cross sectional view of a tire and rim with a sound monitoring device located proximate thereto in accordance with one exemplary embodiment of the present invention.

FIG. 5 is a schematic diagram of an acoustic signal monitoring system in accordance with one exemplary embodiment of the present invention. Sound from a tire is detected by the sound monitoring device and processed by the signal processing device and indicated to a user by the indication device.

FIG. 6 is a front plan view of an instrument cluster incorporated into the dashboard of a vehicle. An indication device in the form of an illuminated lamp is present and indicates to the driver that a tire is experiencing tread belt separation in accordance with one exemplary embodiment of the present invention.

FIG. 7 is a front plan view of an instrument cluster incorporated into the dashboard of a vehicle. The indication device is a text message that is displayed in the instrument cluster in order to notify the driver of tread belt separation in accordance with one exemplary embodiment of the present invention.

FIG. 8 is a histogram showing a comparison of harmonics present in the sound monitoring device output signal versus known harmonics for a potential damage condition in accordance with one exemplary embodiment of the present invention.

### DETAILED DESCRIPTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for an acoustic signal monitoring system capable of warning a driver that a potential damage condition, such as tread belt separation, is occurring. The system does this without requiring the driver to audibly listen for a certain sound and make a judgment as to whether the sound produced by the tire is indicative of a damage condition such as tread belt separation.

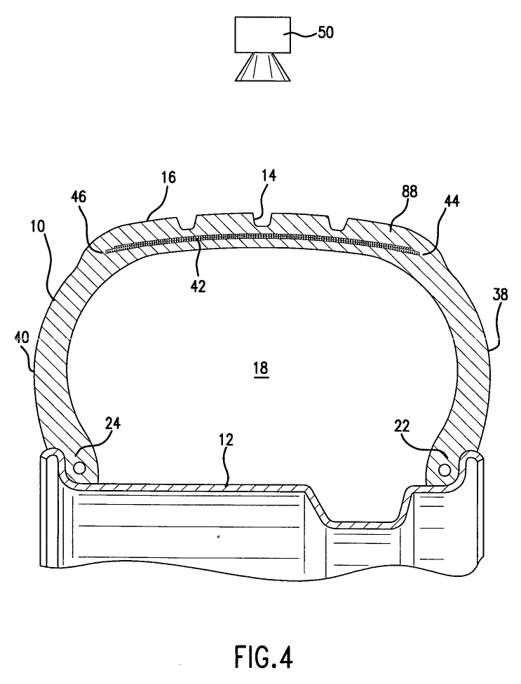

The acoustic signal monitoring system may be used with any type of tire. For instance, FIG. 4 shows a cross sectional view of a tire 10 mounted onto a wheel rim 12 which may be monitored by the acoustic signal monitoring system in accordance with one exemplary embodiment of the present invention. Here, the tire 10 is composed of a first sidewall 38 and a second sidewall 40. The first sidewall 38 has a first bead 22 located on one end thereof. The second sidewall 40 likewise has a second bead 24 located on one end. On opposites ends of the sidewalls 38 and 40, a crown 16 of the tire 10 is incorporated. The present invention may be used with any cross sectional configuration of the sidewalls 38 and 40, beads 22 and 24, and crown 16. The present invention is not limited to the particular configuration shown in FIG. 4. As such, any type of pneumatic or non-pneumatic tire 10 may be used in accordance with the present invention.

A cavity 18 is formed between wheel rim 12 and the tire 10. The crown 16 has tread 14 located thereon. Again, the present invention may be used with tires 10 having any type of tread 14 or those having no tread 14 in other exemplary embodiments of the present invention. The crown 16 also has a radial belt section 42 located therein. The radial belt section 42 has a first side edge 44 and a second side edge 46. These side edges 44 and 46 represent the location where tread belt separation typically initiates. The present invention may be employed with tires 10 having any configuration of the radial belt section 42, and tires 10 where tread belt separation occurs at any location in the tire 10.

Tread belt separation involves the separating of metal cord and rubber layers in the radial belt section 42 from rubber in the crown 16, first sidewall 38 and/or the second sidewall 40. This separation produces voids that generate a distinct “whooping” sound that may be heard by the driver or occupants of the vehicle during rotation of the tire 10. A sound monitoring device 50 is located proximate to the tire 10 in order to detect the sound that the tire 10 makes during rotation.

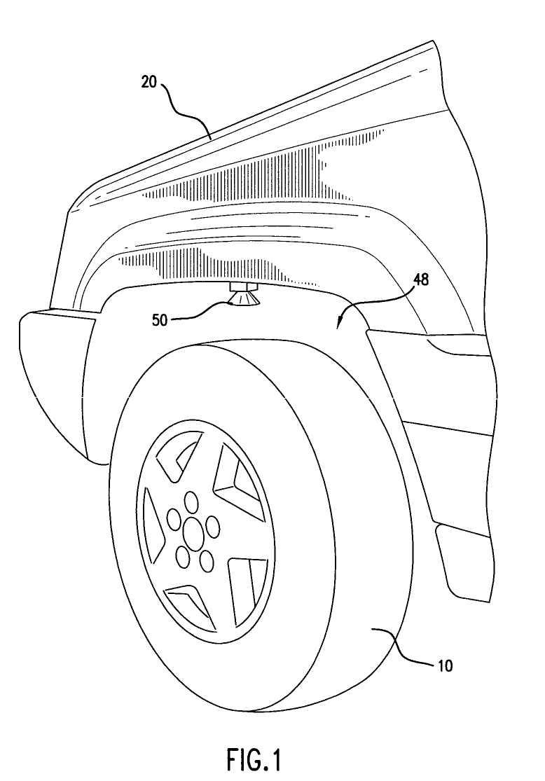

FIG. 1 is a perspective view of a wheel well 48 of a vehicle 20 housing the tire 10. The sound monitoring device 50 is located on the wheel well 48 in close proximity to the tire 10. As such, the sound monitoring device 50 will detect the sound made by the tire 10 as it is rotated within the wheel well 48. As can be imagined, different configurations of the wheel well 48 and the tire 10 will cause different sounds to be detected by the sound monitoring device 50. Additionally, the presence of an undesirable operation condition such as tread belt separation will cause a corresponding change in the sound detected by the sound monitoring device 50.

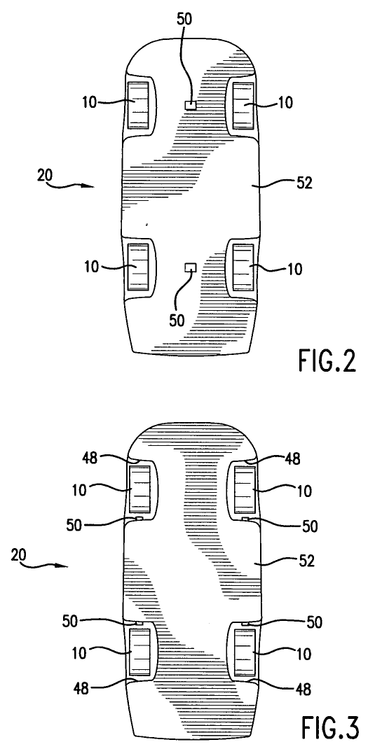

The present invention provides for exemplary embodiments where the sound monitoring device 50 may be located at various positions on or within the vehicle 20 besides the wheel well 48. FIG. 2 shows such an exemplary embodiment where a pair of sound monitoring devices 50 are located on the undercarriage 52 of the vehicle 20. In this instance, the sound monitoring device 50 may be sensitive enough in order to detect the sounds coming from the front tires 10 even though the sound monitoring device 50 is spaced from both of the these tires 10. The additional sound monitoring device 50 may be located in order to detect sounds coming from the back tires 10.

As can be imagined, various placement configurations of the sound monitoring device 50 may be envisioned under the scope of the present invention. For instance, a single sound monitoring device 50 may be employed on the undercarriage 52 of the vehicle 20. This single sound monitoring device 50 may be sensitive enough in order to detect sounds coming from every tire 10 of the vehicle 20, or may be configured only to detect sounds coming from a particular tire 10. Other combinations are possible, such as placement of one sound monitoring device 50 on the undercarriage 52 and placement of a second sound monitoring device 50 within one of the wheel wells 48.

FIG. 3 shows an exemplary embodiment of the present where the vehicle 20 is provided with four tires 10. Four sound monitoring devices 50 are employed in the exemplary embodiment shown in FIG. 3, and each of the sound monitoring devices 50 are positioned in one of the four-wheel wells 48.

An exemplary embodiment of the acoustic signal monitoring system is shown in FIG. 5. Here, the tire 10 produces a sound 54 that is received by the sound monitoring device 50. In turn, the sound monitoring device 50 sends a sound monitoring device output signal 56 to a signal processing device 58. The signal processing device 58 processes the sound monitoring device output signal 56 and produces a processing device output signal 62 that is representative of a potential damage condition of the tire 10. The processing device output signal 62 may be produced once the signal processing device 58 determines that the tire 10 is experiencing the potential damage condition.

Alternatively, the processing device output signal 62 may be continuously generated by the signal processing device 58, the signal indicating the current status of the tire 10. This status could be, for instance, whether the tire 10 is or is not experiencing the potential damage condition, or could be an indication of the severity of the potential damage condition. As such, the processing device output signal 62 is not limited to only situations where the potential damage condition, such as tread belt separation, is occurring. An indication device 64 receives the processing device output signal 62 and indicates to the user or occupants of the vehicle 20 that the tire 10 is experiencing the potential damage condition. The acoustic signal monitoring system may be configured so as to alert the driver that the potential damage condition is occurring in response to any desired amount of tread belt separation.

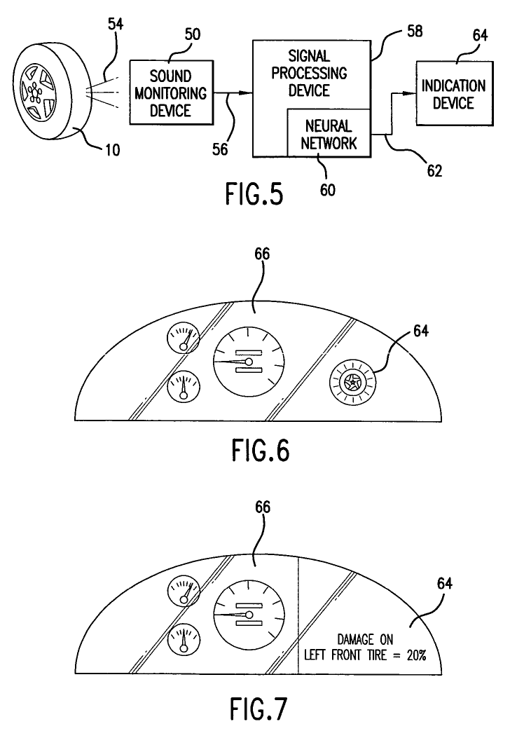

The indication device 64 may be configured in various manners known to those skilled in the art. For instance, FIG. 6 shows an instrument cluster 16 located in the dashboard of the vehicle 20. The indication device 64 is a lamp that is illuminated upon detection of the potential damage condition. This type of an indication to the driver is advantageous in that the driver does not have to determine whether the tire 10 is experiencing tread belt separation, but is instead informed by the acoustic signal monitoring system that the potential damage condition has been detected.

Another configuration of the indication device 64 is shown in FIG. 7. Here, the indication device 64 is displayed as a text message in the instrument cluster 66 of the vehicle 20. The indication device 64 is shown as notifying the driver that the left front tire is experiencing a condition of 20% tread belt separation. The indication device 64 may cycle through all of the tires 10 of the vehicle 20 indicating their various degrees of tread belt separation in other exemplary embodiments of the present invention. Further, the indication device 64 may be configured so as not to display the text message until a certain percentage of tread belt separation occurs. As such, the present invention includes various exemplary embodiments of the indication device 64 and ways of indicating to the driver that the potential damage condition is being detected.

Referring back to FIG. 5, the signal processing device 58 determines whether the potential damage condition is present through the use of a neural network 60. Neural networks are collections of mathematical models that emulate the functioning of a human brain through the use of several simulated processors that are interconnected through a weighted relationship. Where as the typical computer program determines a solution through a serious of deductive steps, a neural network is an inductive program that learns the correct solution through example.

A record having one or more inputs may be presented to the neural network 60, and then analyzed by the neural network 60 in order to determine the correct or expected output. The record may be, for instance, a particular type of tire 10 located on a particular type of vehicle 20, while the input may be the sound produced by this tire 10 during operation. The neural network 60 can first be trained by being provided with training data that has known conclusions. This type of training helps the neural network 60 to determine the correct or expected solution base on the known inputs. After being provided with a series of inputs that have known solutions, the neural network 60 will begin to refine its own architectural structure in order to make sense of patterns present in the data. This type of process is analogous to how a human learns through example. The neural network 60 is capable of identifying and then adjusting the interconnected weights present in the neural network 60 in order to create an internal mapping that is capable of producing a correct or expected output based on the provided input. As such, the neural network 60 is organized by taking data with known outputs and then refining inner connected processors or nodes that interact with one another in order to arrive at a correct solution. As such, a neural network 60 is a non-linear program.

Once the neural network 60 is trained, input records may be placed into the neural network 60 and the correct solution may be obtained. Neural networks 60 are advantageous in that they are capable of recognizing patterns in data and are capable of arriving at solutions upon being given imprecise input records.

The present invention therefore incorporates a neural network 60 within the signal processing device 58. The neural network 60 may be of any type known to those skilled in the art, and the present invention is not limited to a particular type of neural network 60. For example, neural networks 60 may sometime be classified as either feed forward or recurrent. Additionally, neural networks may be “trained” by having known input data with known solutions placed into the neural network first, or neural networks may be self organized in that training data is not first provided to the neural network. The neural network 60 of the present invention includes various exemplary embodiments and is not limited to a particular type.

The neural network 60 may be either contained in a hardware format, a software format, and/or a combination of a hardware/software format. In certain exemplary embodiments of the present invention, the neural network 60 may be a semiconductor or microprocessor. The neural network 60 of the present invention may be provided by Intel Corp. located at 2200 Mission College Blvd., Santa Clara, Calif. 95052. Alternatively, the neural network 60 used in another exemplary embodiment of the present invention may be manufactured by AT&T Labs having offices at 32 Avenue of the Americas, New York, N.Y. 10013.

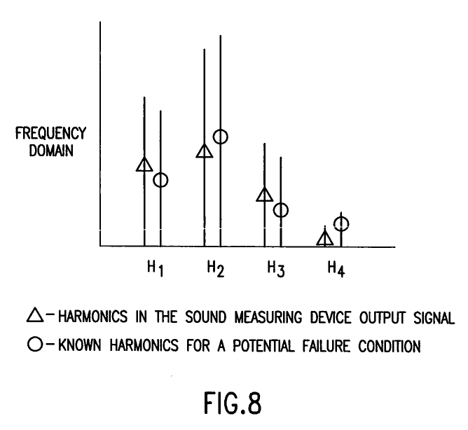

The sound monitoring device output signal may be analyzed by the signal processing device 58 in a number of ways to determine whether the sound made by the tire 10 is representative of a potential damage condition. For instance, in one exemplary embodiment the sound harmonics present in the signal processing device output signal 56 are input into the neural network 60 and compared to known harmonics representative of the potential damage condition of the tire 10. A harmonic is an exact multiple frequency of the original waveform, although lower in amplitude. FIG. 8 shows a histogram comparison of the harmonics in the sound monitoring device output signal 56 to known harmonics for a potential damage condition of the tire 10. Therefore, the neural network 60 may have various harmonics input into the neural network 60 and then compared with known harmonics in order to determine whether the tire 10 is experiencing tread belt separation.

Alternatively or in addition to using harmonics input into the neural network 60, the amplitude and the phase angle of the sound monitoring device output signal 56 may also be entered. Here, the amplitude is the maximum departure of the value of the wave generated by this sound from the average value. The phase angle is the difference between the phase of the sinusoidally varying quantity and the phase of a second quantity which varies sinusoidally at the same frequency. Therefore, the sound monitoring device output signal 56 is broken down into frequency components to obtain the amplitude and the phase angle for each harmonic frequency, and this data is input into the neural network 60. The neural network 60 is trained with the amplitude and phase angle for harmonic frequencies where the sound representative by these values in known to have tread belt separation.

The neural network 60 may then determine whether the tire 10 is experiencing tread belt separation through a comparison of the amplitude and phase angle for each harmonic frequency present in the sound monitoring device output signal 56 versus the known values. Once tread belt separation or a specific degree of tread belt separation is determined, the sound processing device 56 will generate the processing device output signal 62 in order to alert the driver that a potential damage condition is occurring. Although several examples of the data that is input into the neural network 60 in order to analyze the sound monitoring device output signal 56 have been given, it is to be understood that in other exemplary embodiments of the present invention that other values pulled from the sound monitoring device output signal 56 may be used as inputs into the neural network 60 in order to determine whether tread belt separation is occurring. The aforementioned inputs are only exemplary embodiments of the present invention, and it is to be understood that the present invention includes other inputs into the neural network 60 as is known to those skilled in the art.

The neural network 60 may be trained by having sounds generated by the tires 10 in different circumstances that have various degrees of tread belt separation. For instance, Table 1 shown below is one such way of organizing input that will be entered into the neural network 60.

TABLE 1

| | Degree of Tread Belt Separation | | | |
|---|---|---|---|---|
| Make and Model of Vehicle | None | Low | Moderate | High |
| Manufacturer A | | | | |
| Economy Car, X Series | | | | |
| Economy Car, Y Series | | | | |
| Economy Car, Z Series | | | | |
| Luxury Sedan, X Series | | | | |
| Luxury Sedan, Y Series | | | | |
| Luxury Sedan, Z Series | | | | |
| Sports Car, Y Series | | | | |
| Sports Car, Z Series | | | | |
| Manufacturer B | | | | |
| Economy Car, R Series | | | | |
| Economy Car, S Series | | | | |
| Economy Car, T Series | | | | |
| Luxury Sedan, R Series | | | | |
| Luxury Sedan, S Series | | | | |
| Sports Car, R Series | | | | |
| Sports Car, S Series | | | | |
| Manufacturer C | | | | |
| Van, AA Series | | | | |
| Van, BB Series | | | | |
| Sports Utility, AA Series | | | | |
| Sports Utility, BB Series | | | | |
| Sports Utility, CC Series | | | | |

Here, a single tire 10 is used that is of a particular size and shape, with a particular tread 14, and made by a particular manufacturer. This tire 10 is placed on vehicles 20 that are each of a different make and model. The tire 10 has no tread belt separation. Sounds produced upon rotation on these various vehicles 20 of different makes and models are recorded and entered into the neural network 60. The neural network 60 is then told that these sounds represent the tire 10 having no tread belt separation. Next, a tire 10 having a low degree of tread separation is again placed on all of the different vehicles 20 of different makes and models. The respective sounds are input into the neural network 60 and the neural network 60 is told that these sounds represent the tire 10 having a low degree of tread belt separation. This process is then repeated with tires 10 having a moderate and a high degree of tread belt separation.

The neural network 60 may be further trained by having other tires with no, low, moderate, or high degrees of tread belt separation placed on the various vehicles 20 and the resulting sounds input into the neural network 60. As such, the inputs may be reentered into the neural network 60 in order to further refine the architecture of the neural network 60 as discussed above. Once the neural network in sufficiently trained with the various sounds, it may then be incorporated into the acoustic signal monitoring system and used by a user of the vehicle 20.

Table 2 shown below represents another way of organizing the inputs to the neural network 60. Here, tires 10 are placed on vehicles 20 of different makes and models.

TABLE 2

| Make and | Location and Degree of Tread Belt Separation | | | | | | | | | | | | | | | |
|---|---|---|---|---|---|---|---|---|---|---|---|---|---|---|---|---|
| Model of | 1^{st} Wheel Well | | | | 2^{nd} Wheel Well | | | | 3^{rd} Wheel Well | | | | 4^{th} Wheel Well | | | |
| Vehicle | 0% | 20% | 50% | 90% | 0% | 20% | 50% | 90% | 0% | 20% | 50% | 90% | 0% | 20% | 50% | 90% |

Manufacturer A
Economy car,
X Series
Economy Car.
Y Series
Economy Car,
Z Series
Luxury Sedan,
X Series
Luxury Sedan,
Y Series
Luxury Sedan,
Z Series
Sports Car, Y
Series
Sports Car, Z
Series
Manufacturer B
Economy Car,
R Series
Economy Car,
S Series
Economy Car,
T Series
Luxury Sedan,
R Series
Luxury Sedan,
S Series
Sports Car, R
Series
Sports Car, S
Series
Manufacturer C
Van, AA Series
Van, BB Series
Sports Utility,
AA Series
Sports Utility,
BB Series
Sports Utility,
CC Series

The tire 10 is again a tire having a particular configuration, tread 14, size, and made by a particular manufacturer. This tire 10 has 0% tread belt separation. The tire 10 is placed in the first wheel well of the vehicle 20 of a particular make and model, and the resulting sound is input into the neural network 60. The tire 10 may then be placed in the second wheel well of the vehicle 20 and the resulting sound entered. Additionally, the tire 10 is placed in the third and fourth wheel wells of the vehicle 20 and the sounds produced in these wheel wells are input into the neural network 60. Next, a tire 10 that has 20% tread belt separation is placed in the first wheel well of the vehicle 20 that is of a particular make and model. This tire 10 is again placed in the various wheel wells, and the neural networks 60 is provide with inputs from each particular wheel well of the vehicle 20. Further, tires 10 having 50 and 90 % tread belt separation are incorporated into the neural network architecture. Tires 10 having different manufacturers, sizes, tread 14, or configurations may then be placed on the various vehicles 20 in order to further train the neural network 60.

The present invention therefore provides for an acoustic signal monitoring system that may be incorporated into a particular make and model of vehicle, or one that is more universal in nature and can be incorporated into vehicles 20 that are of different makes and models. Additionally, other input may be placed into neural network 60 in order to further refine the architecture of the neural network 60 and/or account for different types of sounds coming from the tire 10 in order to more accurately determine tread belt separation. For instance, the sounds produced by tires 10 having an even amount of tread wear may be input into the neural network 60, and tires 10 having an uneven amount of tread wear may also be placed into the neural network 60. These two different type of tires 10 are all input with varying degrees of tread belt separation. The sounds input into the neural network 60 may be sounds recorded from the various wheel wells 48 of the vehicle 20, or may be sounds made from a pair of the tires 10 when the sound monitoring device 50 is placed on the undercarriage 52 of the vehicle. Alternatively, the sound input into the neural network 60 may come from a single sound monitoring device 50 placed on the undercarriage 52 of the vehicle 20.

It is therefore the case that the neural network 60 may be organized with sounds generated by various types of tires 10 on various types of vehicles 20 where the sound monitoring device 50 is placed in different locations. The training of the neural network 60 may be as extensive as needed in order to refine the neural network architecture to the desired degree of operation. For instance, it may be the case that the sound made by the tire 10 is different at sea level as opposed to higher elevations. The neural network 60 may then be input with sounds coming from the tires 10 at these different locations. Further, the sound made by the tire 10 may be different upon being driven in a tunnel as opposed to a single lane road in the middle of the country. Sounds in these different locations can also be input into the neural network 60 in order to ensure a more accurate output.

Further conditions, such as whether the sound is made upon being driven in the rain, on different types of asphalt or concrete, or in different types of weather may also be incorporated into the neural network 60.

Although described as having 0%, 20%, 50%, and 90% tread belt separation it is to be understood that in other exemplary embodiments of the present invention any percentage of tread belt separation may be used. The various conditions of tires and degrees of tread belt separation are only exemplary embodiments of how the neural network 60 may be configured and are not meant as a limitation of the invention.

Although described as training the neural network 60, in other exemplary embodiments of the present invention the neural network 60 may be self-learning. In these exemplary embodiments, input data is not first placed into the neural network 60. The neural network 60 acts to monitor the sound made by the tire 10 and produce the processing device output signal 62 upon a change in the sound. As such, the present invention includes neural networks 60 that are both self-taught and those that are trained.

In certain exemplary embodiments of the present invention the signal processing device 58 may be made entirely of the neural network 60. In other exemplary embodiments of the present invention the signal processing device 58 may be configured so as to receive the sound monitoring device output signal 56 and process this signal into the appropriate input to be placed into the neural network 60. As such, the present invention includes exemplary embodiments where the signal processing device 58 is completely comprised of the neural network 60, and exemplary embodiments where the signal processing device 58 has other components that are used to refine the sound monitoring device output signal 56 and/or the processing device output signal 62 as determined by the neural network 60.

It should be understood that the present invention includes various modifications that can be made to the exemplary embodiments of the acoustic signal monitoring system for a tire as described herein as come within the scope of the appended claims and their equivalents.

1. An apparatus for monitoring the condition of a tire comprising:
at least one sound monitoring device mountable on a vehicle, the sound monitoring device for producing a sound monitoring device output signal representative of the sound produced by at least one tire of the vehicle during rotation of the tire;
a signal processing device comprising a neural network for receiving and processing the sound monitoring device output signal, the signal processing device producing a processing device output signal representative of a potential damage condition of the tire; and
an indication device for receiving the processing device output signal and indicating to a user of the vehicle that the tire is experiencing the potential damage condition .

2. The apparatus of claim 1, wherein the indication device is selected from the group consisting of a lamp, a light emitting diode, a gage, and an audio indicator.

3. The apparatus of claim 1, wherein the signal processing device produces the processing device output signal upon comparison of harmonics in the sound monitoring device output signal to known harmonics representative of the potential damage condition of the tire.

4. The apparatus of claim 1, wherein the signal processing device produces the processing device output signal upon comparison of an amplitude for each harmonic frequency and a phase angle for each harmonic frequency in the sound monitoring device output signal to known amplitudes for each harmonic frequency and known phase angles for each harmonic frequency representative of the potential damage condition of the tire.

5. The apparatus of claim 1, wherein the signal processing device produces the processing device output signal upon comparison of the sound represented by the sound monitoring device output signal to known sound made by tires having various degrees of tread belt separation.

6. The apparatus of claim 1, wherein the signal processing device produces the processing device output signal upon comparison of the sound represented by the sound monitoring device output signal to known sounds made by tires having at least a different size, configuration, or manufacturer all having various degrees of tread belt separation.

7. The apparatus of claim 1, wherein the signal processing device produces the processing device output signal upon comparison of the sound represented by the sound monitoring device output signal to known sounds made by tires on different makes and model of vehicles having various degrees of tread belt separation.

8. The apparatus of claim 1, wherein the signal processing device produces the processing device output signal upon comparison of the sound represented by the sound monitoring device output signal to known sounds made by tires located in every wheel well of the vehicle having various degrees of tread belt separation.

9. The apparatus of claim 1, wherein the signal processing device produces the processing device output signal upon comparison of the sound represented by the sound monitoring device output signal to known sounds made by tires having even tread wear having various degrees of tread belt separation, and tires having uneven tread wear having various degrees of tread belt separation.

10. The apparatus of claim 1, wherein the vehicle has four tires and four wheel wells, and the sound monitoring devices are four in number and each located in one of the wheel wells proximate to a respective one of the four tires of the vehicle, and wherein the signal processing device produces the processing device output signal upon comparison of the sounds represented by the sound monitoring device output signals to known sounds made by tires located in each of the four wheel wells of the vehicle having various degrees of tread belt separation.

11. The apparatus of claim 1, wherein the indication device indicating that the tire is experiencing a particular percentage of tread belt separation.

12. An apparatus for monitoring the condition of a tire comprising:
at least one sound monitoring device to be carried by a vehicle, the sound monitoring device for producing a sound monitoring device output signal representative of the sound produced by at least one tire of the vehicle during rotation of the tire;
a signal processing device comprising a neural network connected to receive the sound monitoring device output signal and comparing the sound represented by the sound monitoring device output signal to a known set of sounds produced by tires on the same make and model of the vehicle and having various degrees of tread belt separation, the signal processing device producing a processing device output signal upon detecting a predetermined degree of tread belt separation; and
an indication device for receiving the processing device output signal and indicating to a user of the vehicle that the tire is experiencing tread belt separation.

13. The apparatus of claim 12, wherein the signal processing device compares sounds by comparison of harmonics in the sound monitoring device output signal to known harmonics produced by tires on the same make and model of the vehicle having various degrees of tread belt separation.

14. The apparatus of claim 12, wherein the indication device is selected from the group consisting of a lamp, a light emitting diode, a gage, and an audio indicator.

15. The apparatus of claim 12, wherein the signal processing device compares the sounds by comparison of an amplitude for each harmonic frequency and a phase angle for each harmonic frequency in the sound represented by the monitoring device output signal to known amplitudes for each harmonic frequency and known phase angles for each harmonic frequency representative of the sets of sounds produced by tires on the same make and model of the vehicle having various degrees of tread belt separation.

16. The apparatus of claim 12, wherein the signal processing device compares the sound represented by the sound monitoring device output signal to a known set of sounds produced by tires having at least a different size, configuration, or manufacturer all having various degrees of tread belt separation.

17. The apparatus of claim 12, wherein the signal processing device compares the sounds represented by the sound monitoring device output signal to known sounds made by tires located in every wheel well of the vehicle having various degrees of tread belt separation.

18. The apparatus of claim 12, wherein the signal processing device compares the sound represented by the sound monitoring device output signal to known sounds made by tires having even tread wear having various degrees of tread belt separation, and tires having uneven tread wear having various degrees of tread belt separation.

19. The apparatus of claim 12, further comprising a vehicle having four tires and four wheel wells, and wherein four sound monitoring devices are present and each located in one of the wheel wells proximate to a respective one of the four tires of the vehicle, and wherein the signal processing device comparing the sounds represented by the sound monitoring device output signals to known sounds made by tires located in each of the four wheel wells of the vehicle.

20. The apparatus of claim 12, wherein the indication device indicates that the tire is experiencing a particular percentage of tread belt separation.

21. An apparatus for monitoring the condition of a tire comprising:
at least one sound monitoring device to be carried by a vehicle, the sound monitoring device for producing a sound monitoring device output signal representative of the sound produced by at least one tire of the vehicle during rotation of the tire;
a signal processing device comprising a neural network for receiving the sound monitoring device output signal and comparing the sound monitoring device output signal to sounds trained into the neural network from tires having various degrees of tread belt separation, the signal processing device producing a processing device output signal upon detecting a predetermined degree of tread belt separation; and
an indication device for receiving the processing device output signal and indicating to a user of the vehicle that a predetermined degree of tread belt separation is experienced by the tire.
